(19) United States
(12) Patent Application Publication
(10) Pub. No.: US 2023/0042975 A1
(43) Pub. Date: Feb. 9, 2023

(54) METHODS OF BORIC ACID ANALYSIS AND PROCESS CONTROL OF METALLIZATION SOLUTIONS

(71) Applicant: ECI Technology, Inc., Totowa, NJ (US)

(72) Inventors: Jingjing Wang, Livingston, NJ (US); Jong Woung Kim, Weehawken, NJ (US); Patrick Saitta, New York, NY (US); Eugene Shalyt, Washington Township, NJ (US)

(73) Assignee: ECI Technology, Inc., Totowa, NJ (US)

(21) Appl. No.: 17/857,600

(22) Filed: Jul. 5, 2022

Related U.S. Application Data
(60) Provisional application No. 63/228,894, filed on Aug. 3, 2021.

(51) Int. Cl. G01N 31/16

(52) U.S. Cl. CPC G01N 31/16

(57) ABSTRACT

Techniques for selective measurement and monitoring of boric acid concentrations in processing solutions are provided. Methods include the use of a complexing agent that reacts with hydrolyzing ions, for example, ethylenediaminetetraacetic (EDTA) acid salts in potentiometric titration. In such methods, a boric acid concentration in a processing solution can be accurately measured and monitored.

### CROSS-REFERENCE TO RELATED APPLICATIONS

This application claims priority to U.S. Provisional Patent Application Ser. No. 63/228,894 filed Aug. 3, 2021, the contents of which are hereby incorporated by reference herein in its entirety.

### FIELD

The present disclosure relates to analysis and process control of processing solutions, for example, semiconductor processing solutions, and more particularly to techniques for selective measurement and monitoring of boric acid concentrations in such processing solutions.

### BACKGROUND

Processing solutions are used in several industries, including semiconductor industries, to produce products with desired properties. Such processing solutions can include boric acid or boron and its compounds, the analytic determination of which can be useful in the alloy electro/electroless plating, metallurgical, chemical, pharmaceutical, and other industries in which measuring, monitoring and control of such boron compounds is needed. Boric acid can be quantified using several methods including, for example, chromatography, spectrophotometry, inductively coupled plasma atomic emission spectroscopy (ICP-AES), and titrimetry, etc. Titrimetic methods are widely used in monitoring boric acid concentrations in aqueous samples and provide for accurate, efficient, relatively rapid, economic, and with a wide measurement range. Methods include mixing the sample with a polyol (e.g., mannitol) and titrating the resulting mannoboric acid with an alkali solution. The titration end point can be detected potentiometrically, for example, by a glass electrode.

In complexed processing solution samples that include additional acids and/or bases other than boric acid, an initial pH adjustment can be performed prior to the addition of the polyol (e.g., mannitol) to reduce or minimize the matrix interference. This method can have two separate titration trials and uses alkalis to ensure a pH value can reach the set point in the first titration. For the second titration, the polyol (e.g., mannitol) can be added to react with boric acid and decrease the pH, followed by re-titrating with the alkali (e.g., sodium hydroxide (NaOH)) until a predetermined pH value is reached. The boric acid concentration can be calculated based on the different in the alkali consumed in the two titration procedures.

For the accurate determination of boric acid concentrations in metal alloy plating processes with ions, which can hydrolyze (e.g., nickel (Ni), cobalt (Co), and iron (Fe) plating), existing titrimetric methods cannot detect titration end points with accuracy. Precipitation of iron hydroxide (Fe(OH)₂), for example, can be observed near the end of titration. Certain methods do not provide accurate results for determination of boric acid concentration as either the titrations are in two separate trials (e.g., one with and one without the addition of mannitol) with the boric acid content calculated by comparing the titration end volume at a predetermined potential.

Alternatively, the titration can be performed in a two-part titration in one trial (e.g., the addition of mannitol after the first titration) with boric acid content calculated by the second titration end volume to reach the same potential before the addition of mannitol. These ions therefore can be sequestered by complexation in order to enable an accurate end point detection in the potentiometric titration. The complexation compound can interfere with the titration if acting as an acid or base.

Certain methods relate to complexing out certain metal ions when filtering minerals (e.g., ascharite) to produce boric acid for higher purity, however, in the context of analyzing a sample for its boric acid content level. Further, titrations performed on such filtrates can be colorimetric and not potentiometric. Additionally, complexing agents can be used in a nickel (Ni) or nickel (Ni) alloy playing context, however, not to measure boric acid concentration accurately but to achieve certain desired properties resulting in the plated metal/alloy. Other methods include providing additives (e.g., ethanolamine (MEA) or ethylenediaminetetraacetic acid (EDTA)) to the boric acid, for example, to stabilize boric acid or to prevent boron-silex glass formation. Also, complexer additives can be used in certain methods to sequester heavy metal ions in order to prevent breakdown of sulfonate in solution in a system being titrated colorimetrically.

### SUMMARY

It is thus desirable to provide processes and apparatuses to provide for economic, efficient, relatively rapid, and wide measurement ranges for the accurate selective measurement and monitoring of boric acid concentrations in processing solutions. For example, this can be the case when performing a potentiometric titration of boric acid content to determine a concentration thereof.

Certain methods for sequestering, ferrous and ferric ions with a chelating ligand during boric acid measurements and, for example, in nickel (Ni) plating solutions for improved measurements are needed. The present disclosure addresses these and other needs by providing techniques for selective measurement and monitoring of boric acid in processing solutions such as semiconductor processing solutions. Techniques of the present disclosure include the use of a complexing agent to provide for selective and accurate measurement and monitoring of boric acid in solution.

### BRIEF DESCRIPTION OF THE DRAWINGS

FIG. 1 schematically illustrates an exemplary apparatus of the present disclosure for boric acid analysis of processing solutions;

FIG. 2 illustrates the results of the titration of boric acid in the potential (mV) versus the titrant addition volume (mL) for two trials. i.e., with and without the addition of a mannitol complexation reagent in accordance with Example 2;

FIG. 3 illustrates the results of the titration of boric acid in the potential (mV) versus the titrant addition volume (mL) for one trial, i.e., the addition of mannitol after the first titration inflection in accordance with Example 3;

FIG. 4 illustrates the results of a boric acid titration comparison in the potential (mV) versus the titrant addition volume (mL) for with and without use of complexation reagents in accordance with Example 4;

FIG. 5 illustrates the results of the boric acid concentration in slope versus the titrant addition volume (mL) for samples with and without complexation agent in accordance with Example 5;

FIG. 6 illustrates the results of the boric acid concentration in slope versus the titrant addition volume (mL) in accordance with Example 5;

FIG. 7 illustrates the results of the boric acid concentration in slope versus the titrant addition volume (mL) with the X-axis scale (i.e., titrant addition volume (mL)) adjusted by position of the first peak of the titration in accordance with Example 5; and

FIG. 8 illustrates the results of the boric acid concentration in pH as the Y-axis versus the titrant addition volume (mL) as the X-axis in accordance with Example 5.

### DETAILED DESCRIPTION

The present disclosure provides techniques for selective measurement and monitoring of boric acid in processing solutions such as semiconductor processing solutions. In certain aspects, techniques of the present disclosure can provide an accurate, rapid, and efficient method with wide measurement range for boric acid concentration analysis in processing solutions including ions that hydrolyze in aqueous environments. In certain embodiments, methods of the present disclosure can aid in process control of boric acid in metal alloy plating baths such as nickel (Ni), cobalt (Co), and iron (Fe) plating.

Such methods include the use of a complexing agent that can react with hydrolyzing ions, for example, ethylenediaminetetraacetic (EDTA) acid salts in potentiometric titration. In such methods, a boric acid concentration in a processing solution can advantageously be accurately measured and monitored.

Technical terms used in the present disclosure are generally known to those skilled in the art. The phrase “predetermined concentration” as used herein refers to a known, target, or optimum concentration of a component in a solution.

As used herein, the term “selective” or “selectively” refers to, for example, the particular monitoring, measurement, or determination of a characteristic of a specific or particular component. For example, the selective measurement of a halide ion refers to the measurement of one particular or predetermined target halide ion from a plurality of halide ions present in solution.

As used herein, the term “accurate” or “accurately” refers to, for example, a measurement or determination that is relatively close to or near an existing or true value, standard, or known measurement or value. In certain embodiments, the measurement or determination error is less than 5%, and/or the relative standard deviation (RSD) is less than 2%.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

The methods of the present disclosure can be applied to various types of solutions including processing solutions. In certain embodiments, the processing solution can be a semiconductor processing solution.

In certain embodiments, the processing solution can include boric acid or boron and its compounds. A person skilled in the art will appreciate that a wide variation of boric acid or forms of boron and its compounds are suitable for use with the present disclosure. In certain embodiments, the processing solution can include boric acid.

In certain embodiments, the processing solution can include one or more metals, such as e.g., plating metals. A person skilled in the art will appreciate a wide combination of plating metals are suitable for use with the present disclosure. In certain embodiments, the one or more plating metals can include nickel (Ni), cobalt (Co), iron (Fe), or combinations thereof. In certain embodiments, the one or more plating metals can include nickel (Ni). In certain embodiments, the one or more plating metals can include iron (Fe). In certain embodiments, the one or more plating metals can include nickel (Ni) and iron (Fe). In aspects, the processing solution can include one or more additional metals. In certain embodiments, throughout the specification, the processing solution is referred to as a “plating solution” or a “metallizing solution.”

Methods of the present disclosure provide for techniques, for example, to selectively measure and monitor a boric acid concentration in processing solutions. Such methods include the use of a complexing agent that reacts with hydrolyzing ions such as but not limited to ethylenediaminetetraacetic acid (EDTA) salts in a potentiometric titration. In certain embodiments, the complexing agent can include complexation reagents include but not limited to multi-dentate metal chelators such as aminopolycarboxylic acids and their salts (EDTA, DTPA, EGTA and their salts), nitrilotriacetic acid (NTA), iminodisuccinic acid (IDS), polyaspartic acid, S,S-ethylenediamine-N,N′-disuccinic acid (EDDS), methylglycinediacetic acid (MGDA), and L-Glutamic acid N,N-diacetic acid, tetrasodium salt (GLDA), or combinations thereof. Throughout the specification, as would be readily understood by a person of ordinary skill in the art, the complexation reagents are also referred to as chelators, chelating agers or complexers.

In certain embodiments, an alloy plating solution (e.g., a nickel (Ni), cobalt (Co), or iron (Fe) plating sample) can be combined with a complexation reagent. The mixture can be titrated, for example, with sodium hydroxide (NaOH), until a first equilibrium is reached. In certain embodiments, a polyol (e.g., mannitol) can be added to the solution. The titration can be continued until a second equilibrium is reached.

In certain embodiments, the boric acid ion concentration of the processing solution can be determined as follows. In samples comprising plating metals such as iron, a complexing agent can be used, for example, to improve a form of the titration curve. Such titration curve can be utilized to determine a boric acid concentration of the sample, for example, as set forth in the Examples of the present disclosure.

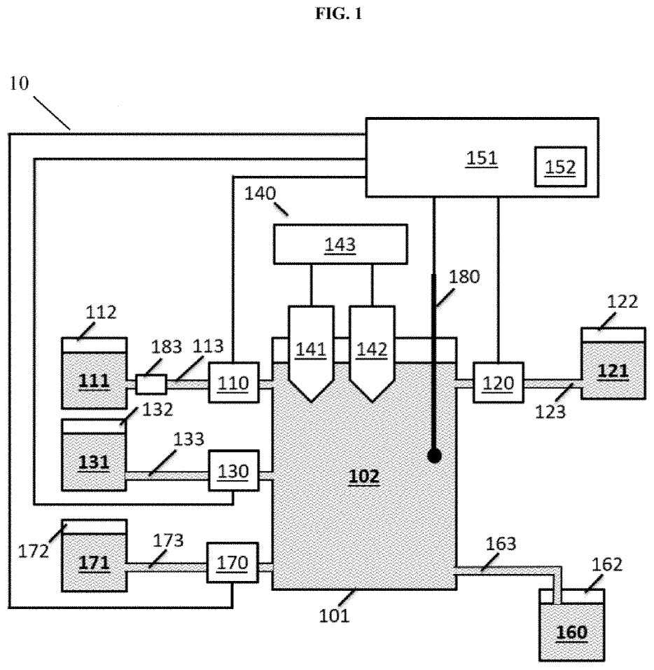

FIG. 1 schematically illustrates an exemplary apparatus 10 of the present disclosure for determining a concentration of boric acid in a metallization solution 111. The apparatus 10 can include an analysis cell 101 containing a test solution 102. The analysis cell 101 can be of any suitable shape, including an open beaker or a closed cell with feedthroughs for the electrodes, for example, and may include any suitable material, glass or a polyolefin plastic, for example. The test solution 102 can include a predetermined volume of the metallization solution 111. In certain embodiments, the test solution 102 can include a predetermined volume of a complexing agent and/or chelator 131 (e.g., ethylenediaminetetraacetic (EDTA) acid salts). The test solution 102 can further include a predetermined volume of a polyol reagent (e.g., mannitol) 171. In certain aspects, the polyol reagent can react with boric acid in the test solution 102 to form a strong acid.

The apparatus 10 can include an introducer 110 for providing the predetermined volume of the metallization solution 111 contained in a sample container 112 to the test solution 102; an introducer 130 for providing the predetermined volume of the complexing agent and/or chelator 131 contained in a container 132 to the test solution 102; and an introducer 170 for providing the predetermined volume of the polyol reagent 171 contained in a container 172 to the test solution 102. In certain embodiments, one or more of the containers 112, 132, 172 can include a reservoir fluidically coupled to the analysis cell 101 and adapted to receive the predetermined volume of the metallization solution 111, complexing agent and/or chelator 131, and the polyol reagent 171, respectively, to the test solution 102.

Suitable introducers 110 for providing the predetermined volume of metallization solution 111 contained in a sample container 112 to the test solution 102 in the analysis cell 101 can include a syringe, a volumetric flask, or a graduated cylinder, for example, for manual delivery, or an automatic syringe, or a metering pump with associate plumbing and wiring, for example, for automatic delivery. Delivery of the predetermined volume of metallization solution 111 can also be performed up to a preset level detected by an automatic level sensor. The sample container 112 can be a production tank or a sample reservoir. For automatic delivery of the metallization solution 111, the introducer 110 can be connected, for example, to a pipe 113 running between the sample container 112 and the analysis cell 101.

Suitable introducers 130 for providing the predetermined volume of the chelating agent and/or chelator 131 from the container 132 to the test solution 102 in the analysis cell 101 can include a syringe, a volumetric flask, or a graduated cylinder, for example, for manual delivery, or an automatic syringe or a metering pump with associated plumbing and wiring, for example, for automatic delivery. Delivery of the predetermined volume of the chelating agent and/or chelator 131 can also be performed up to a preset level detected by an automatic level sensor. The container 132 can be a reservoir. For automatic delivery of the chelating agent and/or chelator 131, the introducer 130 can be connected, for example, to a pipe 133 running between the reagent reservoir 132 and the analysis cell 101.

Suitable introducers 170 for providing the predetermined volume of the polyol reagent 171 contained in the container 172 to the test solution 102 in the analysis cell 101 can include a syringe, a volumetric flask, or a graduated cylinder, for example, for manual delivery, or an automatic syringe or a metering pump with associate plumbing and wiring, for example, for automatic delivery. Delivery of the predetermined volume of the polyol reagent 171 can also be performed up to a preset level detected by an automatic level sensor. The container 172 can be a reservoir. For automatic delivery of the polyol reagent 171, the introducer 170 can be connected, for example, to a pipe 173 running between the container 172 and the analysis cell 101.

The apparatus 10 can further provide for titration of the test solution 102. In certain embodiments, the apparatus 10 can further include one or more devices for the delivery of a base titrant (e.g., sodium hydroxide (NaOH)) to the test solution 102. In certain embodiments, the apparatus 10 can further include one or more devices for the delivery of an acid (e.g., hydrochloric acid (HCl)) and/or water to the test solution 102. By way of example and not limitation, the apparatus 10 can include one or more dilution devices operative to provide a metered flow of water 121 from a water reservoir 122 to the analysis cell 101. For automatic delivery of water 121, the one or more dilution devices can be connected, for example, to one or more pipes 123 running between the water reservoir 122 and the analysis cell 101. In certain embodiments, the apparatus 10 can include a dilution device 120 coupled to the analysis cell 101. The dilution device 120 can include a syringe, a volumetric flask, or a graduated cylinder, for example, for manual delivery, or an automatic syringe or a metering pump with associated plumbing and wiring, for example, for automatic delivery. A computing device or microprocessor 151 can be operative to control the dilution device 120.

A further detector 140 can be provided to detect an endpoint of titration of the test solution 102. For example, in certain embodiments, the apparatus 10 can include one or more electrodes 141, 142. The one or more electrodes 141, 142 can include a pH electrode. In certain embodiments, one or more electrodes 141, 142 can be in contact with a voltmeter or other measuring electronic device 143, for example, to measure the signal output of the one or more electrodes 141, 142.

The computing device or microprocessor 151 having a memory element 152 can be provided with stored instructions operative to effect, via appropriate mechanical and electrical interfacing, the predetermined sequence of operation. The computing device or microprocessor 151 can process output from, for example, the one or more electrodes 141, 142 and can calculate the equivalence point of titration of the test solution 102. In certain embodiments, the computing device or microprocessor 151 can calculate the concentration of boric acid in the test solution 102. The computing device 151 can include a computer with integrated components, or can include separate components, a microprocessor, and a memory device that includes a memory element 152, for example. The memory element 152 can be any one of a combination of available memory elements, including a computer hard drive, a microprocessor chip, a read-only memory (ROM) chip, a programmable read-only memory (PROM) chip, a magnetic storage device, a computer disk (CD) and a digital video disk (DVD), for example. The memory element 152 can be an integral part of the computing device 151 or can be a separate device.

After measurements are completed, the test solution 102 can be flowed via a waste pipe 163 into a waste container 162. Between boric acid analysis determinations, the analysis cell 101 can be rinsed and cleaned, e.g., with water or water spray. The analysis cell 101 can be rinsed using water provided by the dilution device 120 or by a separate rinse system. Thus, there is a drain of chemistry from the reaction vessel. Waste 160 can be disposed.

In certain embodiments, the apparatus 10 can provide for mixing or blending solutions, for example, the test solution 102. In certain embodiments, the apparatus 10 can include one or more stirrers.

In certain embodiments, the apparatus 10 can provide for process adjustments, for example, based on the calculated concentration of boric acid in the test solution 102. For example, the apparatus 10 can provide for each of replenishment of boric acid in the metallization solution 111, dilution with water of the metallization solution 111, partial bleed and feed of the metallization solution 111, or combinations thereof.

In certain embodiments, the apparatus 10 can include a temperature sensor 180, for example, for measuring the temperature of the test solution 102. The temperature sensor 180 can be of any suitable type, including a thermometer, a thermocouple, a thermistor, or an NIR spectrometer, for example. The computing device 151 can be operative to acquire temperature data from the temperature sensor 180.

In certain embodiments, the metallization solution 111 flowed from the metallization tank 112 to the analysis cell 101 can be passed through a cooling device 183, which may include a jacketed portion of the pipe 113 or a heat radiator device, for example.

The apparatuses 10 of the present disclosure can provide for controlling the temperature of the test solution 102. Suitable controls are well-known in the art and can include a hot plate or an immersion heater with feedback from a temperature sensor, which can be used to control the temperature of a liquid in an analysis cell. One technique for controlling the temperature of the test solution 102 is to pass water or another heat exchange liquid form a circulator/controller (or another constant temperature source) through a cooling jacket on the analysis cell 101.

In certain embodiments, various process tools can be used in connection with an analyzer for the methods and apparatuses of the present disclosure for measuring and monitoring boric acid concentration. For example, and not by way of limitation, one or more process tools can supply a predetermined volume of a metallization solution to an analyzer. In certain embodiments, the one or more process tools can extract the predetermined volume of the metallization solution from a recirculation loop. The metallization solution extracted from the recirculation loop can be provided by the one or more process tools to the analyzer for testing. A person skilled in the art will appreciate that various process tools can be used in conjunction with analyzers and such apparatuses can be configured to numerous process systems.

### EXAMPLES

The presently disclosed subject matter will be better understood by reference to the following Examples. The following Examples are merely illustrative of the presently disclosed subject matter and they should not be considered as limiting the scope of the subject matter in any way.

### Example 1: Boric Acid Concentration Determination—Plating Solutions

Methods of the present disclosure provide for the analysis of boric acid concentrations in plating solutions, for example, nickel (Ni), cobalt (Co), or iron (Fe) alloy plating solutions. Boric acid concentrations in such solutions can be determined as follows.

(1) An alloy plating sample (e.g., Ni/Co/Fe alloy plating sample) was added to a beaker with deionized water (DI) water, 0.5 mL of IM hydrochloric acid (HCl), and 20 mL of 0.5 M ethylenediaminetetraacetic acid (EDTA) disodium magnesium and mixed well;

(2) The mixture was titrated with 0.500 M sodium hydroxide (NaOH) (certified standard solution) under stirring until the first equilibrium (reaction inflection) using an automatic potentiometric titrator with pH combination electrode was reached;

(3) 10 mL of 100 g/L mannitol solution was added to (2) under stirring, the potential of the solution increased immediately;

(4) The titration was continued with 0.500M sodium hydroxide (NaOH) until the second equilibrium (reaction inflection). The consumption of sodium hydroxide (NaOH) between the two end points was recorded; and

(5) The boric acid content/concentration in solution was calculated using the concentration of sodium hydroxide (NaOH) standard solution and the consumption of sodium hydroxide (NaOH) standard solution between the titration end points in (4); and the sample volume used in (1) which can be adjusted depending on the concentration of boric acid in the sample.

Boric acid concentration can be measured with error<5% and RSD<2%.

### Example 2: Boric Acid Titration—with and without Mannitol (Prior Methods)

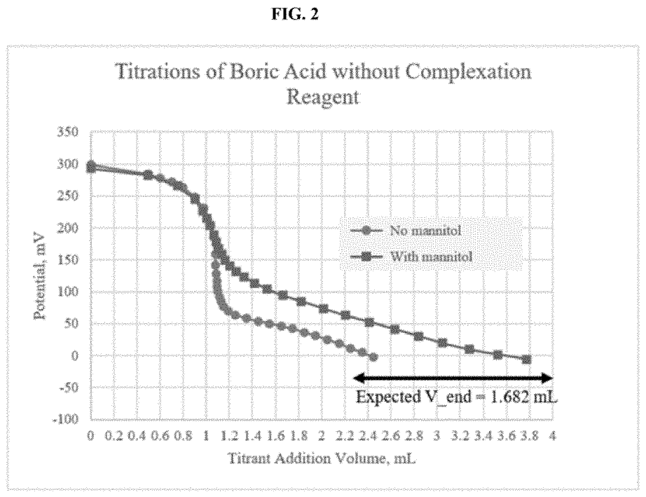

In the present Example, the titration of boric acid in two separate trials was performed, i.e., one with the addition of mannitol and one without mannitol, in accordance with existing methods. The boric acid concentration was calculated by the titrant end volume different at pre-set fixed potential. It was determined to be smaller than the expected value. The results are provided in FIG. 2.

### Example 3: Boric Acid Titration—Mannitol Addition after First Inflection (Prior Methods)

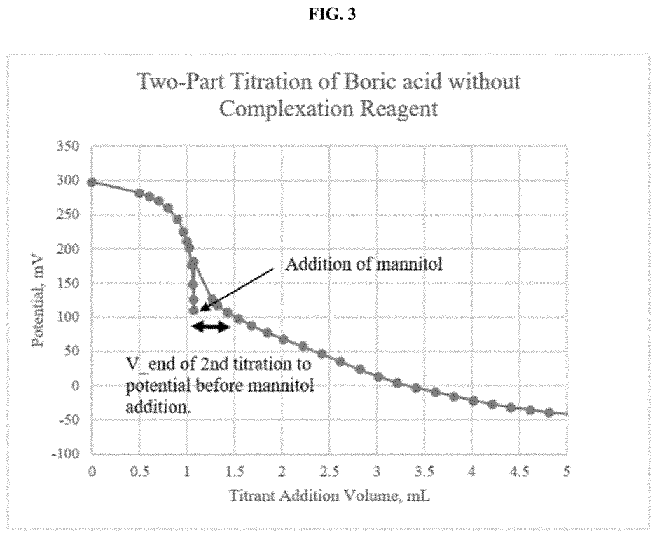

In the present Example, the titration of boric acid was performed with the addition of mannitol after the first titration inflection, in accordance with existing methods. The boric acid concentration was calculated by the second titration end volume that reaches the same potential before the addition of mannitol. The second titration end volume was found to be 0.354 mL, much smaller than the expected value (1.682 mL) was determined to be smaller than the expected value. The results are provided in FIG. 3.

### Example 4: Boric Acid Titration—Curve Comparison with and without Use of Complexation Reagents

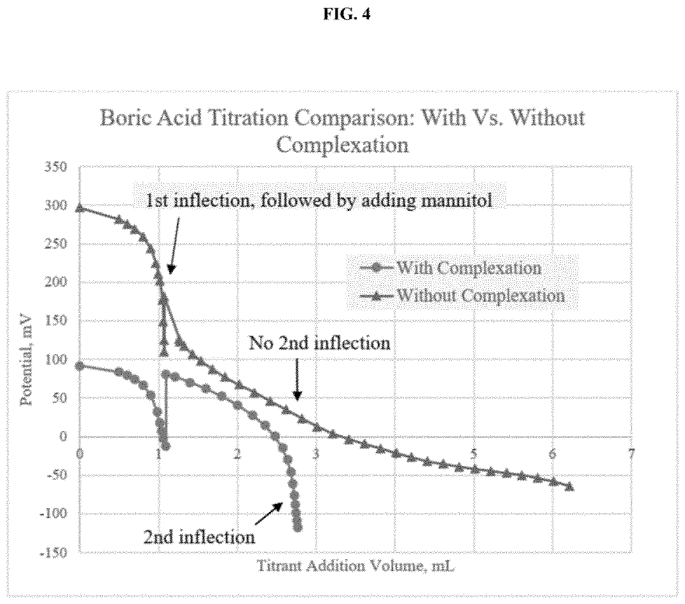

In the present Example, a titration curve comparison of boric acid with and without the use of complexation reagents was performed. The boric acid titration curve with a complexation reagent shows two sharp titration inflections, and the titrant volume difference between these two was used to calculate boric acid concentration. The boric acid titration curve without a complexation reagent shows one inflection. The second inflection after the addition of mannitol was not detectable. The results are provided in FIG. 4.

### Example 5: Boric Acid Titration—Sample Preparation and Titration with Complexation Reagent

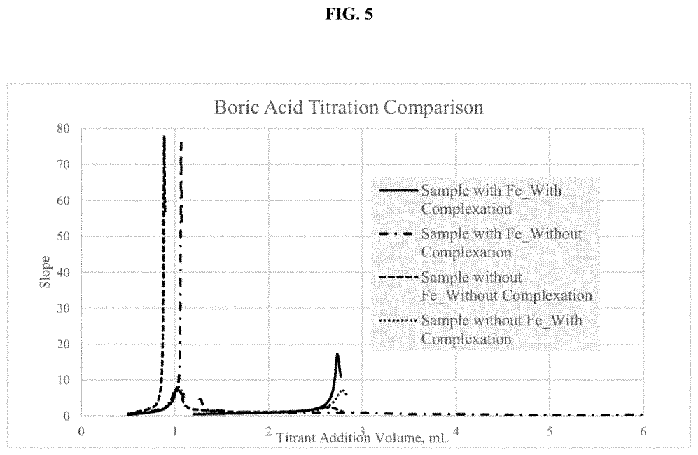

In the present Example, Samples 1-5 were prepared as provided in Table 1 below. Each sample was measured with the use of a complexation reagent. Without a complexation reagent, the end point of the boric acid titration was not detectable. The results are provided in Table 1 below and FIGS. 5-7. The use of a complexer provided improvement including for solutions without hydrolyzing ions.

TABLE 1

| | | Ferrous sulfate | Nickel sulfate | | | |
|---|---|---|---|---|---|---|
| | Prepared | heptahydrate | hexahydrate | Measured | Error of | |
| | boric acid, | (FeSO₄•7H₂O), | (NiSO₄•6H₂O), | Boric, | Boric, | |
| Sample | g/L | g/L | g/L | g/L | g/L | RSD |
| 1 | 26 | 9 | 144 | 25.88 | −0.46% | 0.42% |
| 2 | 18 | 13 | 111 | 18.08 | 0.45% | 0.16% |
| 3 | 34 | 17 | 177 | 33.01 | −2.91% | 0.23% |
| 4 | 18 | 17 | 177 | 18.87 | 4.83% | 0.19% |
| 5 | 34 | 9 | 11 | 33.03 | −2.86% | 0.43% |

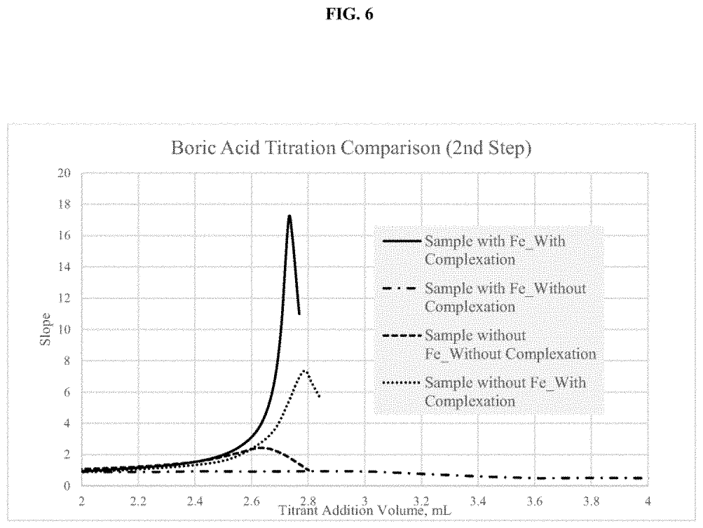

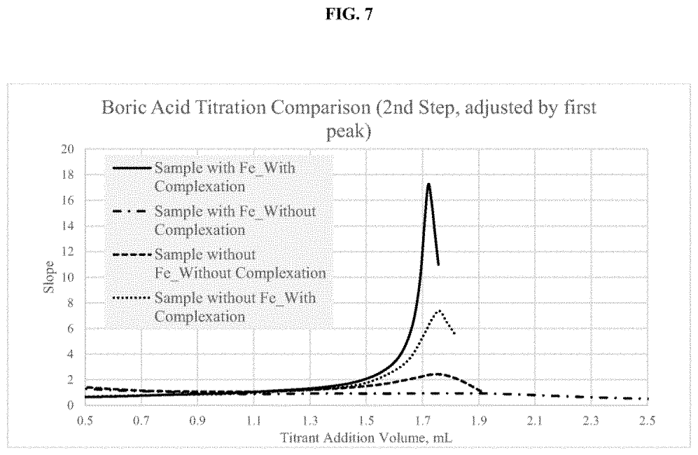

As shown in FIG. 5, the boric acid concentration was measured based on the space between two peaks. In the absence of hydrolyzing ions (e.g., Fe), the peak is detectable even without the complexer. However, the complexer enhances the peak. If the hydrolyzing ion (e.g., Fe) is present, the peak is detectable only in the presence of the complexer. FIG. 6 provides the results of boric acid concentration in slope versus the titrant addition volume (mL). FIG. 7 further provides an adjusted X-axis scale adjusted by the position of the first peak.

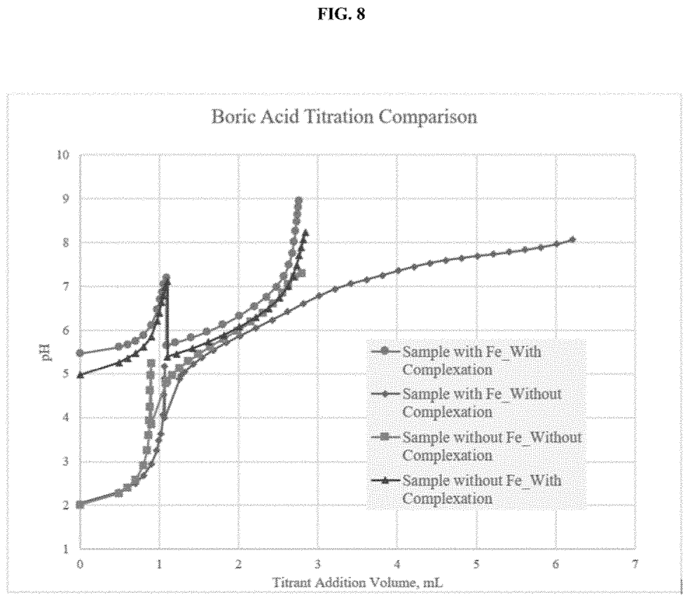

As shown in FIG. 8, the titration equivalence point was defined as an inflection point. The inflection point is well defined in the presence of a complexer (with or without hydrolyzing ions). Without a complexer, it is difficult to measure in the absence of hydrolyzing ions and not measurable in the presence of hydrolyzing ions.

The description herein merely illustrates the principles of the disclosed subject matter. Various modifications and alterations to the described embodiments will be apparent to those skilled in the art in view of the teachings herein. Accordingly, the disclosure herein is intended to be illustrative, but not limiting, of the scope of the disclosed subject matter. Moreover, the principles of the disclosed subject matter can be implemented in various configurations and are not intended to be limited in any way to the specific embodiments presented herein.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter.

1. A method of measuring concentration of boric acid in a processing solution, the method comprising:
adding a complexing agent to the processing solution; and
performing a potentiometric titration to determine the concentration of boric acid.

2. The method of claim 1, wherein the processing solution is a semiconductor processing solution.

3. The method of claim 1, wherein the processing solution comprises a plating metal selected from the group consisting of nickel, cobalt, iron, and combinations thereof.

4. The method of claim 3, wherein the processing solution comprises nickel.

5. The method of claim 3, wherein the processing solution comprises iron.

6. The method of claim 3, wherein the processing solution comprises nickel and iron.

7. The method of claim 3, wherein the processing solution comprises one or more additional metals other than nickel, cobalt, or iron.

8. The method of claim 1, wherein the complexing agent is selected from the group consisting of ethylenediaminetetraacetic acid, aminopolycarboxylic acid, nitrilotriacetic acid, iminodisuccinic acid, polyaspartic acid, S,S-ethylenediamine-N,N′-disuccinic acid, methylglycinediacetic acid, L-Glutamic acid, N,N-diacetic acid, salts thereof, and combinations thereof.

9. The method of claim 8, wherein the complexing agent is aminopolycarboxylic acid or a salt thereof, wherein the aminopolycarboxylic acid is selected from the group consisting of ethylenediaminetetraacetic acid, diethylenetriaminepentaacetic acid, ethylene glycol-bis (β-aminoethyl ether)-N,N,N′,N′-tetraacetic acid, and combinations thereof.

10. The method of claim 1, wherein the potentiometric titration comprises titration with an alkali solution until a first equilibrium is reached.

11. The method of claim 10, wherein the alkali solution is sodium hydroxide.

12. The method of claim 1, further comprising addition of a polyol to the processing solution after the first equilibrium is reached and
titration with sodium hydroxide until a second equilibrium is reached.

13. The method of claim 12, wherein the polyol is mannitol.

14. The method of claim 1, further comprising determining the boric acid concentration based on a difference between an amount of an alkali solution used to reach the first equilibrium and an amount of the alkali solution used to reach the second equilibrium.
